(19) United States
(12) Patent Application Publication
(10) Pub. No.: US 2010/0214893 A1
(43) Pub. Date: Aug. 26, 2010

(54) COPY PROTECTION USING COMPLEXITY AND UNCOMPUTABILITY

(76) Inventor: Adrian R. Aylward, Newbury (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/392,809

(22) Filed: Feb. 25, 2009

(51) Int. Cl. G11B 7/00

(52) U.S. Cl. 369/53.21; G9B/7; 369/275.3

(57) ABSTRACT

A method and system for copy protection using complexity and uncomputability are disclosed. According to one embodiment, a computer-implemented method comprises placing protection structures on a media disc. The protection structures comprise complexity structures and imcomputability commands. Unauthorized reproduction of data stored on the media disc is impeded using the protection structures.

The present invention relates to a method and a system for copy protection using complexity and uncomputability.

### BACKGROUND

Unauthorized reproduction of protected digital content is a common issue for copyrighted, media. Though media discs have become increasingly sophisticated in their structures to make it more difficult to copy the media, programs referred to as ‘ripper’ programs have also become more sophisticated at analyzing which structures on the media disc are to be copied, A successful analysis produces an unauthorized copy of a media file.

DVD (also known as “Digital Versatile Disc” or “Digital Video Disc”) is a popular optical, disc storage media format. Its main uses are video and data storage. Most DVDs are of the same dimensions as compact discs (CDs) but store more than six times as much data. DVD recordables are now also used for consumer audio and video recording.

Existing ripper programs are installed onto a user's computer and work with the existing local DVD drive. They are commonly used to transfer video on DVDs to different formats, to edit or back up DVD content, and for converting DVD video for playback on media players and mobile devices. Some DVD ripper programs include additional features, such as the ability to decrypt DVDs, remove copy preventions and make disks unrestricted and region-tree. Examples of existing ripper programs include DVDFab (Fengtao Software Inc., Beijing, China) and CloneDVD (DVD X Studios, Kaysvlile, Utah, USA).

### SUMMARY

A method and system for copy protection using complexity and uncomputability are disclosed. According to one embodiment, a computer-implemented method comprises placing protection structures on a media disc. The protection structures comprise complexity structures and uncomputability commands. Unauthorized reproduction of data stored on the media disc is impeded using the protection structures.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 is an exemplary diagram of structures commonly residing on a DVD.

FIG. 2A is an exemplary diagram of additional substructures contained within common structures residing on a DVD.

FIG. 2B is an exemplary diagram of additional language unit substructures contained within common structures residing on a DVD.

FIG. 3 is an exemplary diagram of an improved DVD title and pointer structure for copy protection using complexity, according to one embodiment.

FIG. 4 is an exemplary diagram of an improved DVD title and pointer structure for copy protection using complexity, according to an embodiment.

FIG. 5A is a flow diagram illustrating a process for DVD copy protection using uncomputability, according to one embodiment.

FIG. 5B is a flow diagram illustrating a process for DVD copy protection using uncomputability, according to an embodiment.

FIG. 6 is a flow diagram illustrating a process for DVD copy protection using uncomputability, according to an embodiment.

FIG. 7 is a process flow diagram illustrating the steps of a process used to modify a DVD for copy protection, according to one embodiment.

FIG. 8 is a process flow diagram detailing the steps of a process used to modify a DVD for copy protection and replicate it at a DVD replication she, according to one embodiment.

### DETAILED DESCRIPTION

A method and system for copy protection using complexity and uncomputability are disclosed. According to one embodiment, a computer-implemented method comprises placing protection structures on a media disc. The protection structures comprise complexity structures and uncomputability commands. Unauthorized reproduction of data stored on the media disc is prevented using the protection structures.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below, in addition, the present invention is not described with reference to any particular programming language. It will be appreciated that a variety of programming languages may be used to implement the teachings of the invention as described herein.

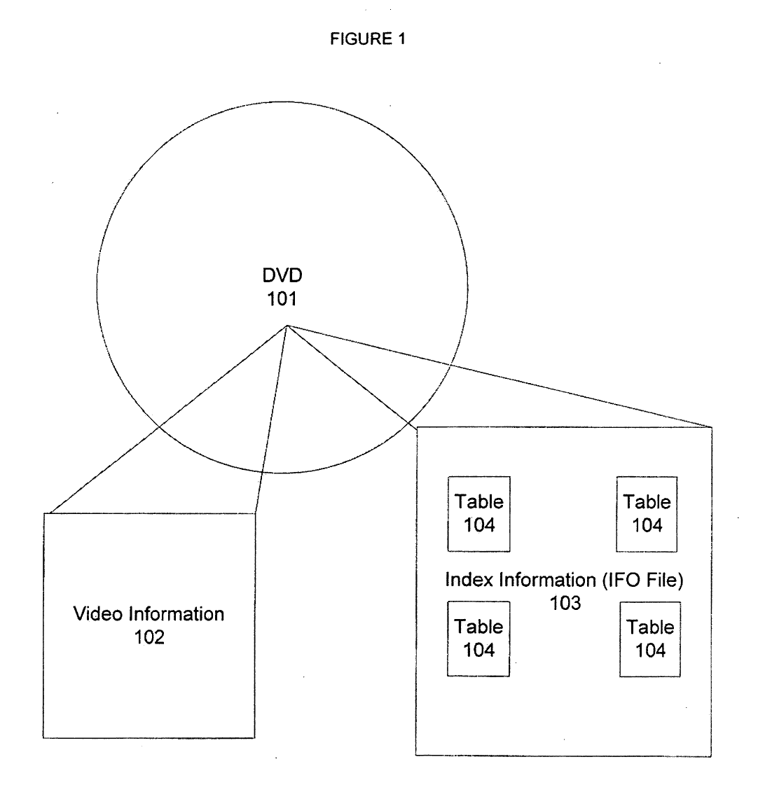

FIG. 1 is an exemplary diagram of structures commonly residing on a DVD. A DVD 101 contains both video information 102 and index information 103 (or an IFO file 103, short for “InFOrmation” file). The IFO file 103 contains several tables 104 to aid in determining what IS on the DVD 101 without having to view it all completely or sequentially.

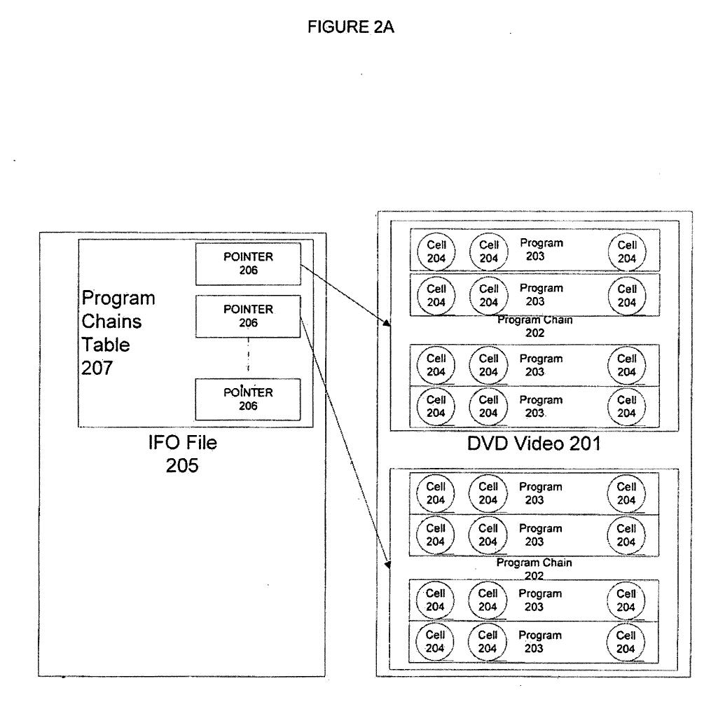

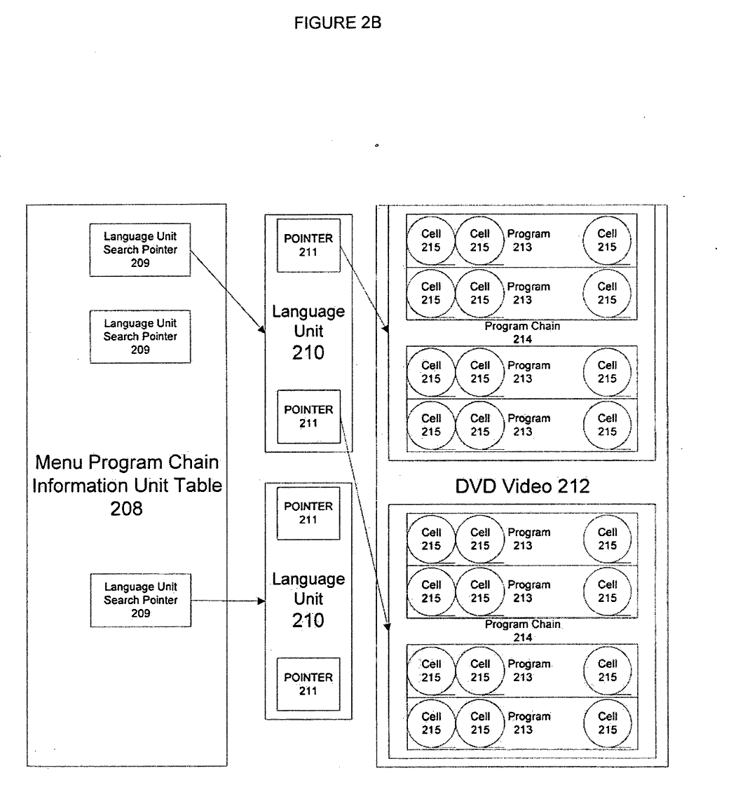

FIG. 2A is an exemplary diagram of additional substructures contained within common structures residing on a DVD. A DVD video section 201 contains several program chains 202, the program chains 202 contain several programs 203, and the programs 203 contain several cells 204. An IFO file 205 contains a program chains table 207, and contained within the program chains table 207 are several pointers 206 which point to program chains 202. The program chains 202 are contained within the DVD video section 201.

FIG. 28 is an exemplary diagram, of additional language unit substructures contained within common structures residing on a DVD. A DVD video section 212 contains several program chains 214, the program chains 214 contain several programs 213, and the programs 213 contain several cells 215, A menu program chain information unit table 208 contains several language unit search pointers 209, and the language unit search pointers 209 reference language units 210. The language units 210 contain several program chain search pointers 211 that reference program chains 214 contained within the DVD video section 212.

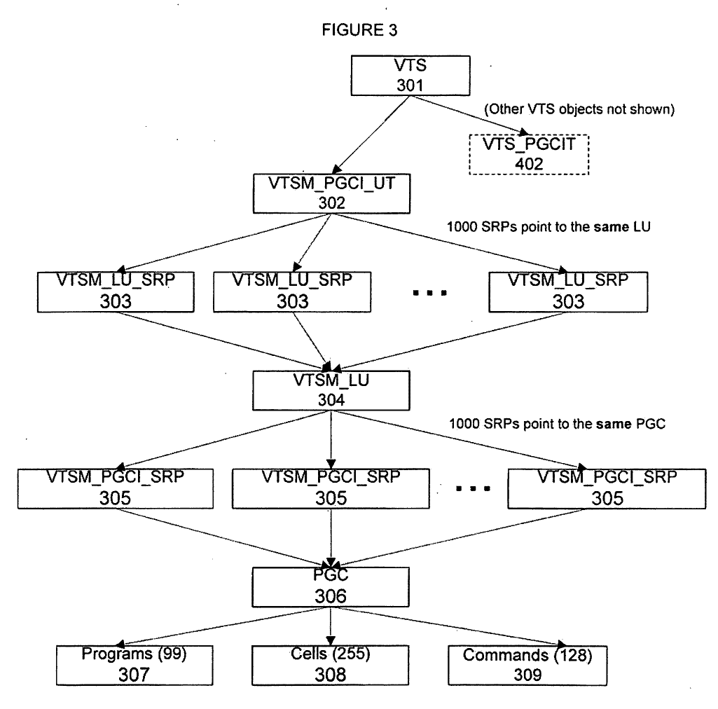

FIG. 3 is an exemplary diagram of an improved. DVD title and pointer structure for copy protection, according to one embodiment. A video title set 301 (VTS) references a menu program chain information unit table 302 (VTSM_PGCI_UT) that contains language unit search pointers (VTSM_LU_SRP) 303. A typical DVD may have several language options, examples of which include English, German, French, and Spanish.

According to one embodiment there can be 1000 language unit search pointers 303 to add complexity to the DVD structure for copy protection against a ripper program. Each of the 1000 language unit search pointers 303 points to the same language unit 304 (VTSM_LU). In other embodiments the pointers 303 point to several different language units 304. The language unit 304 contains references to program chain information search pointers (VTSM_PGCI_SRP) 305. In the illustrated embodiment the number of program chain search pointers is 1000.

Each program chain search pointer 305 points to the same program chain (PGC) 306. In other embodiments the program chain search pointers 305 do not point to the same program chain 306. The program chain 306 points to several programs 307. The programs 307 contain cells 308. The cells 308 contain commands 309. According to the illustrated embodiment, there are 99 programs 307, 255 cells 308, and 128 commands 309. The actual number of objects present is 1+1+1000+1+9+255+128 which totals to 2486. The apparent number of objects (what is seen by a ripper program) is 1+1+1000*(1+1000*(1+99+255+128)) which totals to 483,001,002. These numbers, by way of example, illustrate the complexity introduced by the pointer structure of the present system and method.

A ripper program attempts to analyze every structure to determine which, elements to copy. By increasing the apparent number of objects, the ripper program's chances of success are significantly reduced. Typically, the large number of objects causes the ripper program to run out of resources, or die analysis takes an inordinate amount of time.

A DVD player analyzes the current navigation path to determine which element, to play next. Therefore, a player is not affected by protection structures if the structures are placed out of the way of the player. In one embodiment, the protection structures are placed in a video title set that is not actually played. In most cases the player ignores an unplayed video title set and does not attempt to load and interpret the associated IFO file.

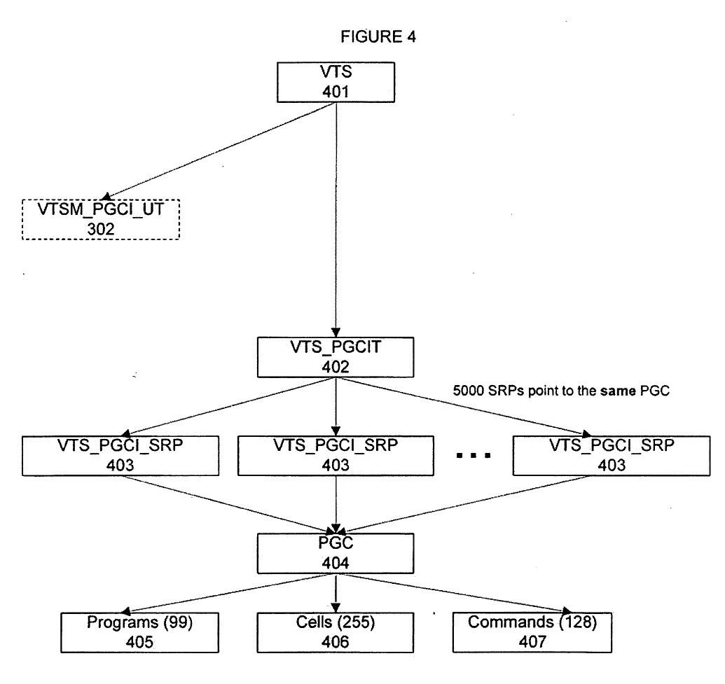

FIG. 4 is an exemplary diagram of an improved DVD title and pointer structure for copy protection, according to an embodiment. A video title set 401 (VTS) references a program chain information table 402 (VTS_PGCIT). The program chain information table 402 contains program chain search pointers (VTS_PGCI_SRP) 403. In the illustrated embodiment the number of program chain search pointers is 5000. Each program chain search pointer 403 points to the same program chain (PGC) 404. In other embodiments the program chain search pointers 403 do not point to the same program chain 404. The program chain 404 points to several programs 405. The programs 405 contain cells 406. The cells 406 contain commands 407. According to the illustrated embodiment, there are 99 programs 307, 255 cells 308, and 128 commands 309. The actual number of objects present is 1+1+5000+1+99+255+128 which totals to 5485. The apparent, number of objects (what is seen by a ripper program) is 1+1+5000*(1+99+255+128) which totals to 2415002. These numbers, by way of example, also illustrate the complexity introduced by the pointer structure of the present system and method.

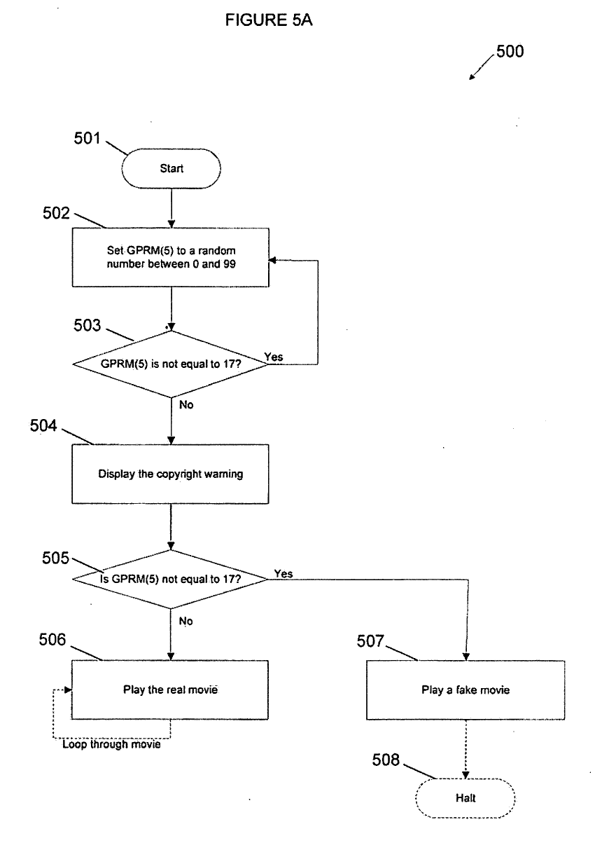

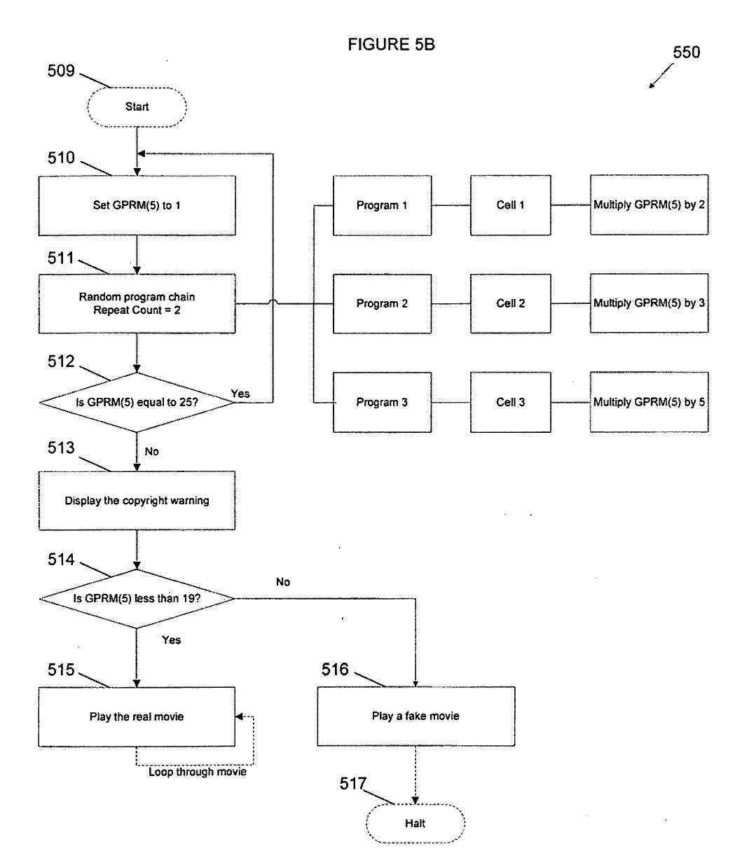

FIG. 5A is a flow diagram illustrating a process for DVD copy protection using uncomputability, according to one embodiment. According to a process 500 for DVD copy protection using uncomputability, a DVD player starts at a step 501 to play a DVD. The DVD player loops generating random numbers at a step 502 between 0 and 99 until the number 17 is generated at a step 503. The test in the step 503 ensures a step 504 is not reached unless the number generated is equal to 17. The copyright warning is displayed at a step 504, the warning being a short video clip which is present on most commercially released DVDs. Once again the random number is tested at a step 505, and if the right value (here, 17) is not found, a fake movie is played, at a step 507 and the program halts at a step 508. Otherwise, the real movie is played at a step 506.

As can be seen from the step 503 and onwards, the value of the random number should be 17. It is however difficult for a computer program, to automatically recognize this. This is a consequence of a well known result in the theory of computer science commonly known as the halting problem. As illustrated in FIG. 5A, the DVD does not halt if the real movie is played and halts if the fake movie is played. The DVD and its player have the essential features of a small computing engine: namely parameter registers and the commands to process them. According to the halting problem it is impossible to write a computer program to decide whether a generic DVD halts when presented with a sequence of input signals, and consequently it is impossible to decide which movie is played. Therefore a ripper program is not able to properly analyze the DVD contents and find the appropriate structures to copy. The input, signals might be generated, fern the viewer operating the DVD player controls such as the menu selection buttons, or as in this example, the input signals are generated, by the random number generator built into the player. In other embodiments, the halt at the end of the fake movie is not used. For instance, the step 508 may be removed and/or replaced fey another sequence of commands. The halt is chosen to illustrate that the halting problem applies and by implication that it is difficult for the ripper to determine which movie is the real one. In other embodiments, the copyright warning is omitted, or replaced by a menu.

FIG. 5B is a flow diagram illustrating a process 550 for DVD copy protection using uncomputability, according to an embodiment. According to a process 550 for DVD copy protecting using uncomputability, a DVD player starts at a step 509 to play a DVD and it sets a parameter to 1 at a step 510. A random program chain, is then displayed at a step 511. The random program chain has programs, with cells and commands. Also at the step 511, the repeat count of the random program chain is set to 2 so that one of the programs is randomly chosen and displayed. At the end of the program the parameter is multiplied by 2, 3, or 5 depending on which program, was chosen, as an example. The program chain then again chooses and displays a random program until two programs have been displayed. In this example, the value of the parameter after the program chain has been displayed should be 4, 6, 9, 10, 15, or 25 depending on which two programs were chosen. The parameter is tested at a step 513 and if the value is 25 the player returns to the step 502. Otherwise the copyright warning at a step 514 is displayed and the parameter is tested at a step 515. If at the step 515 the value of the parameter is 4, 6, 9, 10 or 15 then the real movie is played at a step 516. Otherwise, the fake movie is played at a step 517. In the embodiments shown in FIGS. 5A and 5B, the halting problem applies. In FIG. 5B the input signals are generally provided by the viewer operating the player controls. Consequently, the ripper program is not able to properly analyze the DVD contents and find file appropriate structures to copy. Also, the copyright notice and/or the halt are removed or replaced in other embodiments.

In another embodiment, a shuffle program chain is used instead of a random program chain. The shuffle program chain selects and displays randomly chosen programs without selecting the same program twice. In this example, the possible values in the parameter afterwards are therefore 6, 10, or 15. The test at the step 513 is preferably amended to test whether the parameter is equal to 15 and the test at the step 515 is amended to test whether the parameter is less than 13.

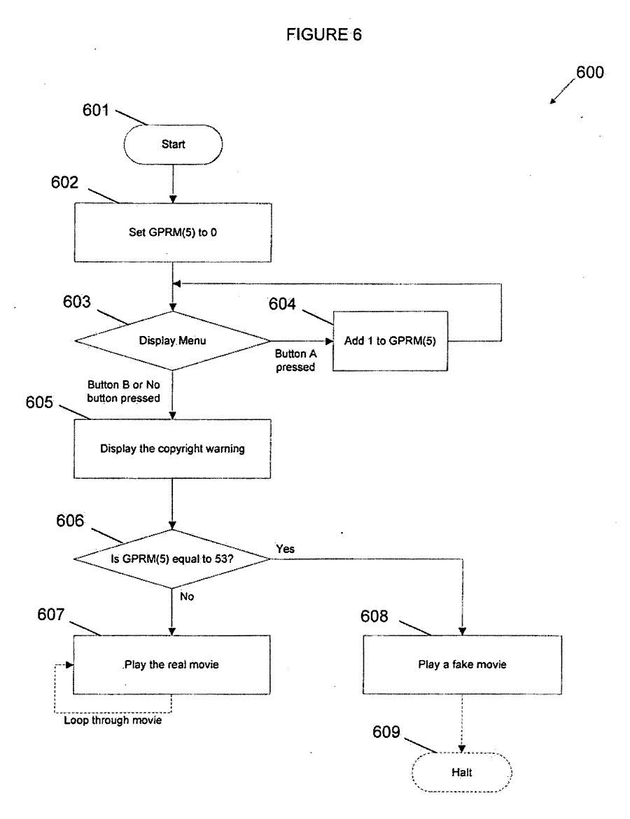

FIG. 6 is a flow diagram illustrating a process for DVD copy protection using uncomputability, according to an embodiment. According to a process 600 for DVD copy protection using uncomputability, a DVD player starts at the step 601 to play the DVD. The DVD player initializes at a step 602 a parameter number to zero and displays a menu, at a step 603 with two buttons. If a button A is pressed then the parameter is incremented at a step 604 and the menu at a step 603 is displayed again. If a button B is pressed, or if no button is pressed within a predetermined time, the player continues at a step 605 and the copyright warning is displayed, A test at a step 606 ensures that only if button A is pressed exactly 53 time, then a fake movie at a step 608 is displayed. It is rather unlikely that the viewer will do this, so he is almost sure to see the real movie at a step 607.

As illustrated in the embodiments shown in FIGS. 5A and 5B, the halting problem applies. In the example of FIG. 6 the input signals are provided by the viewer operating the player controls. Consequently, the ripper program is not able to properly analyze the DVD contents and fed file appropriate structures to copy. Also, as described above in relation, to FIGS. 5A and 5B the copyright notice and/or the halt is removed, or replaced in other embodiments.

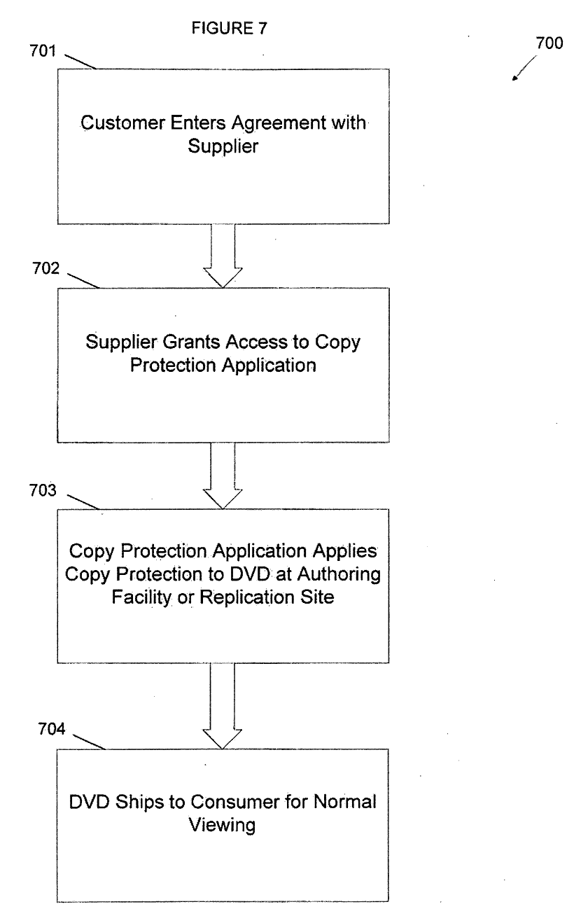

FIG. 7 is a flow diagram illustrating the steps in a process used to modify a DVD for copy protection, according to one embodiment. According to a process 700 used to modify a DVD for copy protection, a customer enters an agreement with a supplier at a step 701. The supplier grants access to the copy protection application at a step 702, which modifies a DVD to include copy protection using complexity and/or uncomputability. The copy protection application is utilized at the authoring or replication site at a step 703. Once replication is complete the DVD ships to the consumer for normal viewing at a step 704.

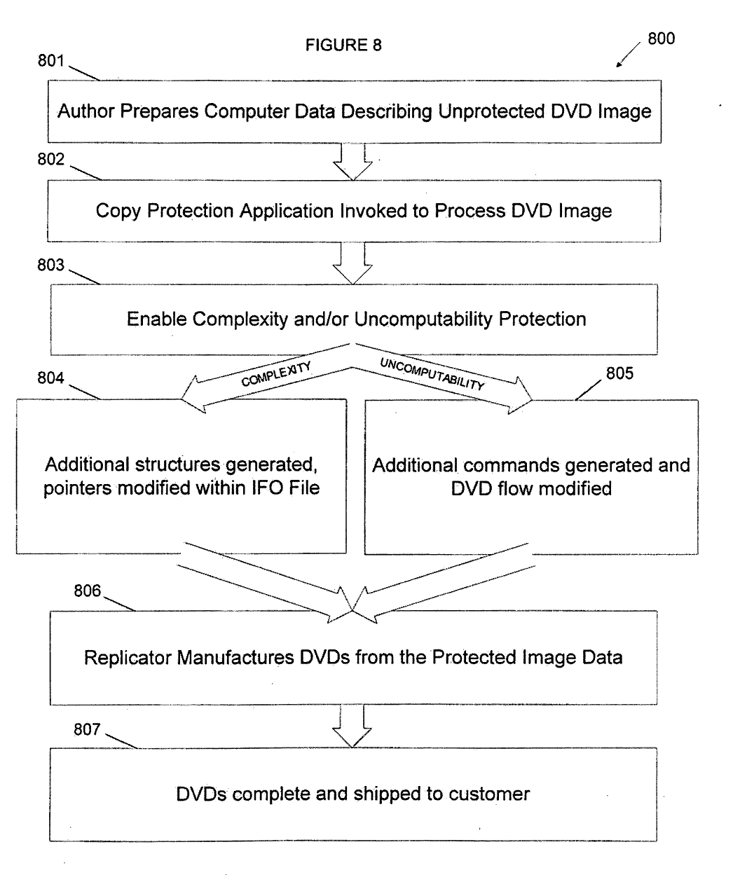

FIG. 8 is a flow diagram detailing the steps of a process used to modify a DVD for copy protection and replicate it at a DVD replication site, according to one embodiment. According to a process 800, as shown in this figure, an author prepares computer data describing the unprotected DVD image at a step 801. A copy protection application is then invoked at a step 802 to process the DVD image and enable copy protection using complexity and/or uncomputability at a step 803. In some embodiments both types of copy protection are utilized on the same DVD. For the complexity option at the step 804, structures are generated and placed within the IFO file on the DVD, and pointers are appropriately updated. For the uncomputability option at a step 805, additional commands are generated and the DVD flow is modified accordingly. The replicator manufactures the DVDs from the protected image data at a step 807 and the DVDs are then complete and shipped to the consumer at a step 808.

The methods presented herein are described as being implemented on a DVD, however the methods are applicable to any media with similar properties.

A method and system for copy protection using complexity and uncomputability is disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

I claim:

1. A computer-implemented method, comprising:
placing protection structures on a media disc, the protection structures having complexity structures; and
impeding unauthorised reproduction of data stored on the media disc using the protection structures.

2. The computer-implemented method of claim 1, wherein the complexity structures are placed within an information file, the complexity structures comprising one or more of:
language units;
language unit search pointers;
program chain search pointers;
programs;
program chains; and
cells.

3. The computer-implemented method of claim 1, wherein the protection structures are placed on the media disc at an authoring site.

4. The computer-implemented method of claim 1, wherein the protection structures are placed on the media disc at a replicator site.

5. A computer-implemented method, comprising:
placing protection structures on a media disc, the protection structures having uncomputability commands; and
impeding unauthorized reproduction of data stored on the media disc using the protection structures.

6. The computer-implemented method of claim 5, wherein the uncomputability commands comprise one or more of:
random number generation commands;
random program chains;
shuffle program chains; and
commands created by operation of player controls by a user.

7. The computer-implemented method of claim 5, wherein the protection structures are placed on the media disc at an authoring site.

8. The computer-implemented method of claim 5, wherein the protection structures are placed on the media disc at a replicator site.

9. A computer-readable medium having stored thereon a plurality of instructions, said plurality of instructions when executed by a computer, cause said computer to perform:
placing protection structures on a media disc, the protection structures having complexity structures; and
impeding unauthorized reproduction of data stored on the media disc using the protection structures.

10. The computer-readable medium of claim 9, wherein the complexity structures are placed within an information file, the complexity structures comprising one or more of:
language units;
language unit search pointers;
program chain search pointers;
programs;
program chains; and
cells.

11. A computer-readable medium having stored thereon a plurality of instructions, said plurality of instructions when executed by a computer, cause said computer to perform:
placing protection structures on a media disc, the protection structures having uncomputability commands; and
Impeding unauthorized reproduction of data stored on the media disc using the protection structures.

12. The computer-readable medium of claim 11, wherein the uncomputability commands comprise one or more of:
random number generation commands;
random program chains;
shuffle program chains; and
commands created by operation of player controls by a user.

13. A system, comprising:
a media disc;
protection structures, the protection structures having complexity structures;
means for placing the protection structures on the media disc; and
means for impeding unauthorized reproduction of data stored on the media disc using the protection structures.

14. The system of claim 13, wherein the complexity structures are placed within an information file, the complexity structures comprising one or more of:
language units;
language unit, search pointers;
program chain search pointers;
programs;
program chains; and
cells.

15. The system of claim 13, wherein the protection, structures are placed on the media disc at an authoring site.

16. The system of claim 13, wherein the protection structures are placed on the media disc at a replicator site.

17. A system, comprising:
a media disc;
protection structures, the protection structures having uncomputability commands;
means for placing the protection structures on the media disc; and
means for impeding unauthorized reproduction of data stored on the media disc using the protection structures.

18. The system of claim 17, wherein the uncomputability commands comprise one or more of:
random, number generation commands;
random program chains;
shuffle program chains; and
commands created by operation of player controls by a user.

19. The system of claim 17, wherein the protection structures are placed on the media disc at an authoring site.

20. The system of claim 17, wherein the protection structures are placed on the media disc at a replicator site.
